(19) United States
(12) Patent Application Publication
(10) Pub. No.: US 2026/0018725 A1
(43) Pub. Date: Jan. 15, 2026

(54) BATTERY PACK

(71) Applicant: TOYOTA JIDOSHA KABUSHIKI KAISHA, Toyota-shi (JP)

(72) Inventors: Shinya GOITSUKA, Nisshin-shi (JP); Hiroshi OTAKE, Toyota-shi (JP)

(73) Assignee: TOYOTA JIDOSHA KABUSHIKI KAISHA, Toyota-shi (JP)

(21) Appl. No.: 19/237,141

(22) Filed: Jun. 13, 2025

(30) Foreign Application Priority Data
Jul. 11, 2024 (JP) 2024-111498

(51) Int. Cl. H01M 50/24; H01M 10/42; H01M 50/204; H01M 50/262; H01M 50/503

(52) U.S. Cl. CPC H01M 50/24; H01M 10/425; H01M 50/204; H01M 50/262; H01M 50/503; H01M 2220/20

(57) ABSTRACT

A battery pack includes a battery module, an equipment member disposed on the battery module, and a supporting member disposed between the battery module and the equipment member and formed of insulation resin. A busbar having electrical conductivity is disposed in the supporting member, one end of the busbar that has passed through the inside of the supporting member toward the battery module side is connected to the battery module, a connection terminal is provided on the other end of the busbar that has passed through the inside of the supporting member toward the equipment member side, and the connection terminal of the busbar is connected to a connection terminal of the equipment member.

### CROSS-REFERENCE TO RELATED APPLICATION

This application claims priority to Japanese Patent Application No. 2024-111498 filed on Jul. 11, 2024. The disclosure of the above-identified application, including the specification, drawings, and claims, is incorporated by reference herein in its entirety.

### BACKGROUND

### 1. Technical Field

The present disclosure relates to a battery pack.

### 2. Description of Related Art

A battery pack in which a high-voltage equipment member is disposed on an upper portion of a battery module and the battery module and the high-voltage equipment member are wired with a high-voltage electric wire has been known (for example, see Japanese Unexamined Patent Application Publication No. 2022-081322 (JP 2022-081322 A)).

### SUMMARY

However, for example, when slack occurs in the high-voltage electric wire, there is a concern that the high-voltage electric wire may come into contact with another high-voltage portion.

The present disclosure has been made in view of the problem as above and a main object thereof is to provide a battery pack capable of reliably preventing a high-voltage electric wire and another high-voltage portion from coming into contact with each other.

One aspect of the present disclosure for achieving the object described above is a battery pack including a battery module, an equipment member, and a supporting member. The equipment member is disposed on the battery module, and the supporting member is disposed between the battery module and the equipment member and is formed of insulation resin. In the battery pack, a busbar having electrical conductivity is disposed in the supporting member, one end of the busbar that has passed through the inside of the supporting member toward the battery module side is connected to the battery module, a connection terminal is provided on the other end of the busbar that has passed through the inside of the supporting member toward the equipment member side, and the connection terminal of the busbar is connected to a connection terminal of the equipment member.

In this one aspect, the equipment member may be fixed onto an equipment base, a first protruding portion that protrudes to the equipment member side may be provided on the supporting member on one side of the supporting member, the connection terminal may be provided on the other end of the busbar that has passed through an upper end surface of the first protruding portion, a second protruding portion that protrudes to the equipment member side may be provided on the supporting member on another side of the supporting member, an upper end surface of the second protruding portion may abut against a lower surface of the equipment base and support the lower surface, and a gap may be provided between the upper end surface of the first protruding portion and the lower surface of the equipment base.

In this one aspect, a plurality of the battery modules may be disposed in parallel to each other in a battery case, and the supporting member may be disposed between adjacent ones of the battery modules along a side surface of each of the battery modules.

In this one aspect, the battery module may be fixed to a battery case via a bracket, the supporting member may be fixed to the bracket, the equipment member may be fixed onto an equipment base, and the equipment base may be fixed to the bracket.

In this one aspect, the supporting member may be formed of a flame-retarded resin, and the busbar may be formed by insert-molding of the flame-retarded resin of the supporting member.

With the present disclosure, it becomes possible to provide the battery pack capable of reliably preventing the high-voltage electric wire and the other high-voltage portion from coming into contact with each other.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view in which a battery pack according to an embodiment of the present disclosure is decomposed;

FIG. 2 is a perspective view of the battery pack according to the present embodiment seen from diagonally above;

FIG. 3 is a sectional view of the battery pack according to the present embodiment taken across line AA;

FIG. 4 is a perspective view of a supporting member according to the present embodiment seen from diagonally above; and

FIG. 5 is a view of battery modules seen from above.

### DETAILED DESCRIPTION OF EMBODIMENTS

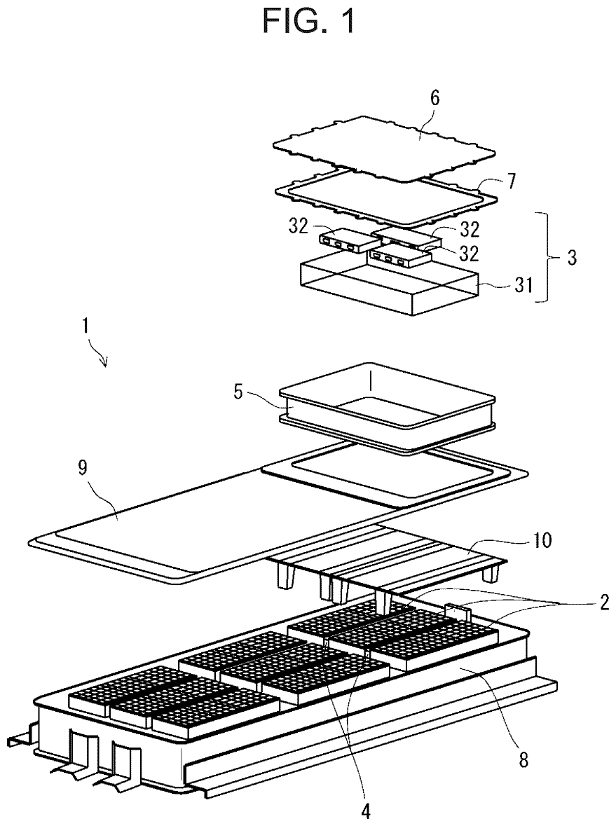

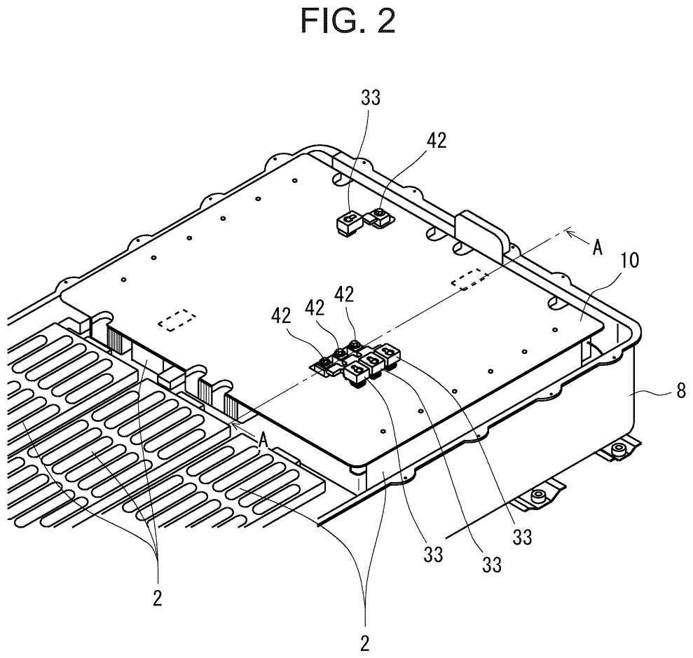

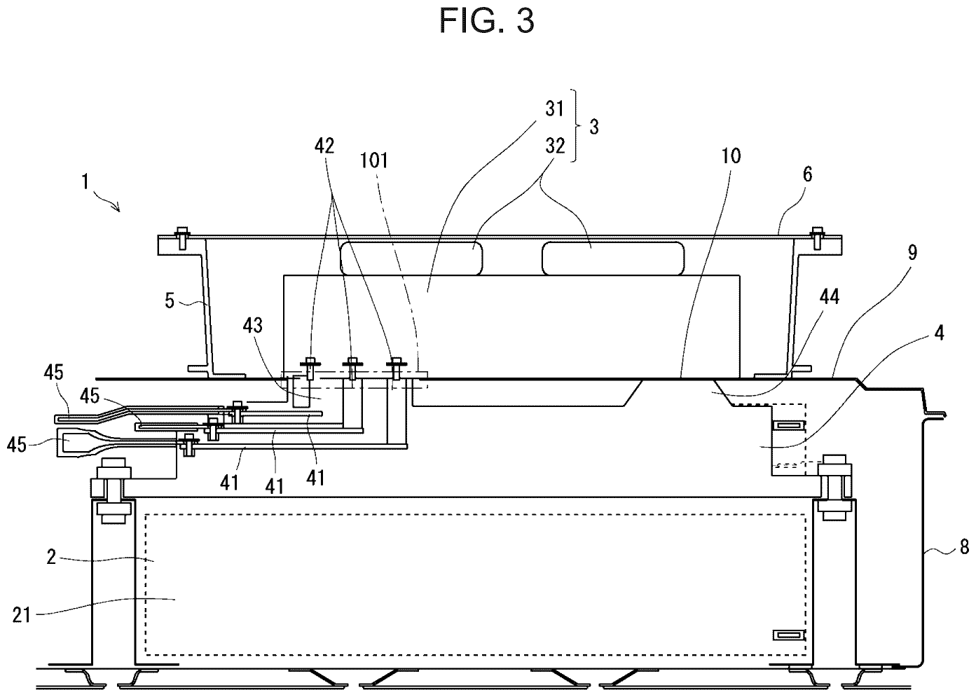

An embodiment of the present disclosure will be described below with reference to the drawings. FIG. 1 is an exploded perspective view in which a battery pack according to the present embodiment is decomposed. FIG. 2 is a perspective view of the battery pack according to the present embodiment seen from diagonally above. FIG. 3 is a sectional view of the battery pack according to the present embodiment taken across line AA. In FIG. 2, members above an equipment base 10 are partially omitted such that the diagram becomes easy to see.

A battery pack 1 according to the present embodiment includes a plurality of battery modules 2, an equipment member 3 disposed on the battery modules 2, and a plurality of supporting members 4 disposed between the battery modules 2 and the equipment member 3.

Each of the battery modules 2 is formed by stacking a plurality of film-form battery cells 21 in the depth direction in FIG. 3, for example. The battery cells 21 are configured by lithium-ion batteries, nickel cadmium batteries, nickel hydride batteries, or the like.

The battery pack 1 is mounted on a vehicle (a battery electric vehicle, a hybrid electric vehicle, or the like) including an electric motor such as a motor as a driving source, for example, and serves to feed electricity to the electric motor, for example. The battery modules 2 are housed in a battery case 8. An upper end of the battery case 8 is covered by an upper end cover 9.

The equipment member 3 has a junction box 31 in which a plurality of wiring routes, a plurality of switches, and the like are formed, and a plurality of electronic control units (ECUs) 32 fixed onto the junction box 31. The junction box 31 is fixed onto the equipment base 10. The junction box 31 and each ECU 32 are electrically connected to each other by wiring and the like.

The equipment member 3 is housed in an equipment case 5. Lower end edges of the equipment case 5 are fixed to the equipment base 10 by bolts and nuts. The upper side of the equipment case 5 is covered by an equipment cover 6. Upper end edges of the equipment case 5 and end edges of the equipment cover 6 are fastened by fastening members such as bolts and nuts via a gasket 7 and the like.

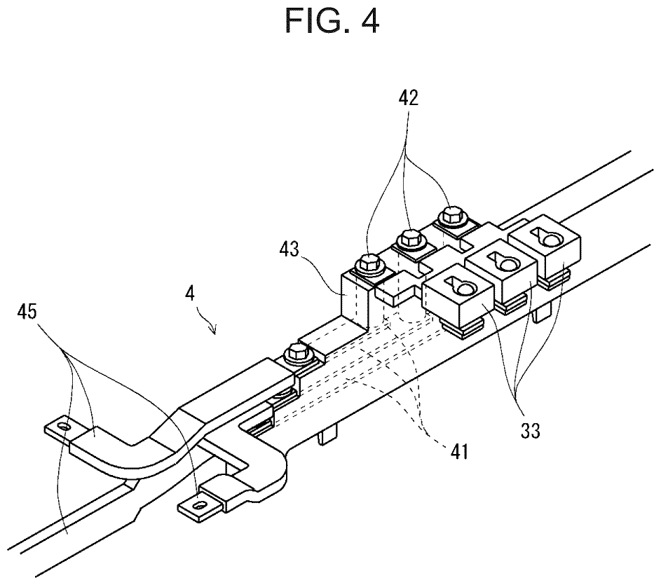

FIG. 4 is a perspective view of the supporting member 4 according to the present embodiment seen from diagonally above. As shown in FIG. 3 and FIG. 4, a plurality of busbars 41 having electrical conductivity is disposed in the supporting member 4.

The supporting member 4 is a rod-like member and is preferably formed of flame-retarded resin, such as polyetheretherketone (PEEK) and polytetrafluoroethylene (PTFE), for example. The busbars 41 are formed by insert-molding of the flame-retarded resin of the supporting member 4 and are fully covered.

The busbars 41 can be electrically and thermally protected in a reliable manner by covering the high-voltage busbars 41 by the supporting member 4 formed by the flame-retarded resin as above. In other words, a case in which the high-voltage busbars 41 and another high-voltage portion come into contact with each other can be reliably prevented.

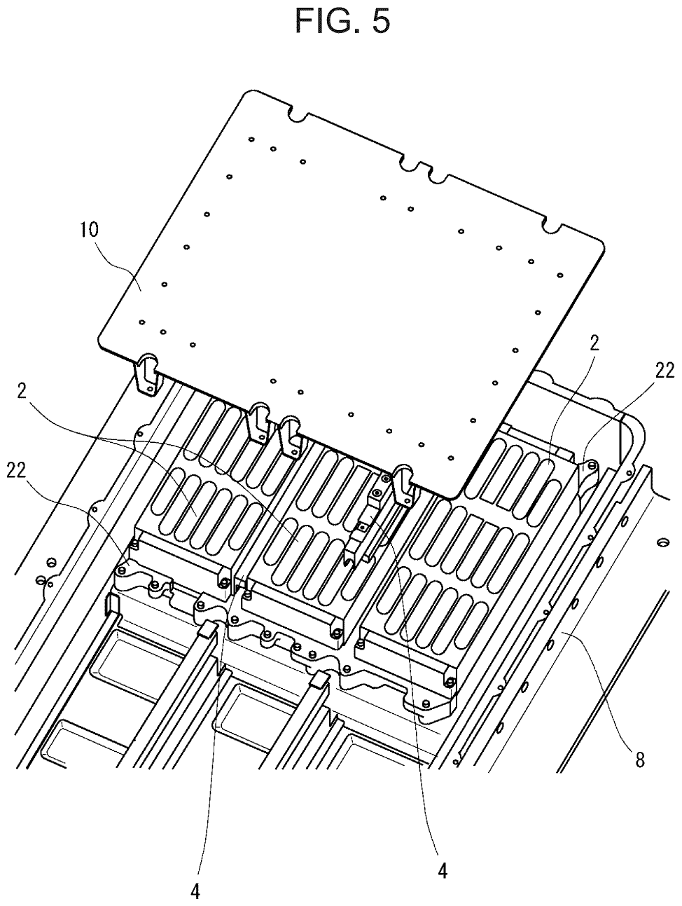

FIG. 5 is a view of the battery modules seen from above. The supporting member 4 is disposed between the adjacent battery modules 2 along side surfaces of the battery modules 2. As a result, the supporting member 4 functions as a dividing wall member that provides thermal insulation between the battery modules 2.

The battery modules 2 are fastened and fixed to the battery case 8 that is a structure member via module brackets 22. The supporting members 4 are rigidly fixed to the module brackets 22 by mechanical fastening and the like. The equipment base 10 to which the equipment member 3 is fixed is fixed to the module brackets 22.

As above, the battery modules 2, the equipment base 10 to which the equipment member 3 is fixed, and the supporting members 4 are assembled to the same reference members, that is, the module brackets 22. As a result, the tolerance between the battery modules 2 and the equipment member 3 can be reduced. Therefore, input to terminal fastening portions (fastening portions between the connection terminals 42 and the connection terminal bases 33 described later) of the busbars 41 can be reduced, and looseness thereof can be prevented.

As shown in FIG. 3, the junction box 31 and the battery modules 2 are electrically connected to each other via the busbars 41 in the supporting members 4. One end of each busbar 41 that has passed through the inside of the supporting member 4 toward the battery module 2 side is connected to the battery module 2 via a connection member 45 and the like.

A connection terminal 42 is formed on the other end of the busbar 41 that has passed through the inside of the supporting member 4 toward the equipment member 3 side. As above, by disposing the busbars 41 on the inside of the supporting member 4 and providing the connection terminals 42 on distal ends thereof, function integration of the supporting member 4 and the connection terminals 42 can be performed and a mounting efficiency thereof can be improved.

A first protruding portion 43 that protrudes to the equipment member 3 side (upper side) is formed on the supporting member 4 on one side of the supporting member 4.

20 The connection terminals 42 are provided on the other ends of the busbars 41 that have passed through an upper end surface of the first protruding portion 43. The first protruding portion 43 and the connection terminals 42 pass through a relief hole 101 formed in the equipment base 10 and are exposed on the equipment base 10.

As shown in FIG. 2 and FIG. 4, the connection terminal bases 33 are provided on a lower surface of the junction box 31. The connection terminals 42 of the busbars 41 are connected to the connection terminal bases 33 of the junction box 31. As a result, as described above, the junction box 31 and the battery modules 2 are electrically connected to each other via the busbars 41.

As shown in FIG. 3, a second protruding portion 44 that protrudes to the equipment member 3 side may be formed on the supporting member 4 on the other side of the supporting member 4. An upper end surface of the second protruding portion 44 abuts against a lower surface of the equipment base 10 and supports the lower surface. As a result, the load from the equipment base 10 can be reliably supported by the second protruding portion 44 of the supporting member 4, and hence vibration generated in the equipment member 3 on the equipment base 10 can be reduced.

Meanwhile, a gap is provided between the upper end surface of the first protruding portion 43 and the lower surface of the equipment base 10. As a result, vibration input to the connection terminals 42 of the busbars 41 can be avoided. In other words, by the configuration of the first protruding portion 43 and the second protruding portion 44 of the supporting member 4, a vibration isolation structure of the equipment member 3 can be secured, and the vibration input to the connection terminals 42 of the busbars 41 can be reduced.

Some embodiments of the present disclosure have been described above, but those embodiments are presented as examples and are not intended to limit the scope of the disclosure. Those novel embodiments can be carried out in various other forms and can be variously omitted, replaced, combined, and changed without departing from the gist of the disclosure. Those embodiments and their modifications are included in the scope and gist of the disclosure and are included in the scopes of the disclosure described in the claims and their equivalents.

What is claimed is:

1. A battery pack, comprising: a battery module;
an equipment member disposed on the battery module; and
a supporting member disposed between the battery module and the equipment member and formed of insulation resin, wherein:
a busbar having electrical conductivity is disposed in the supporting member;
one end of the busbar that has passed through an inside of the supporting member toward the battery module side is connected to the battery module;
a connection terminal is provided on another end of the busbar that has passed through the inside of the supporting member toward the equipment member side; and
the connection terminal of the busbar is connected to a connection terminal of the equipment member.

2. The battery pack according to claim 1, wherein:
the equipment member is fixed onto an equipment base;
a first protruding portion that protrudes to the equipment member side is provided on the supporting member on one side of the supporting member;
the connection terminal is provided on the other end of the busbar that has passed through an upper end surface of the first protruding portion;
a second protruding portion that protrudes to the equipment member side is provided on the supporting member on another side of the supporting member;
an upper end surface of the second protruding portion abuts against a lower surface of the equipment base and supports the lower surface; and
a gap is provided between the upper end surface of the first protruding portion and the lower surface of the equipment base.

3. The battery pack according to claim 1, wherein:
a plurality of the battery modules is disposed in parallel to each other in a battery case; and
the supporting member is disposed between adjacent ones of the battery modules along a side surface of each of the battery modules.

4. The battery pack according to claim 1, wherein:
the battery module is fixed to a battery case via a bracket;
the supporting member is fixed to the bracket;
the equipment member is fixed onto an equipment base; and
the equipment base is fixed to the bracket.

5. The battery pack according to claim 1, wherein:
the supporting member is formed of a flame-retarded resin; and
the busbar is formed by insert-molding of the flame-retarded resin of the supporting member.
